(19) United States
(12) Patent Application Publication
(10) Pub. No.: US 2015/0199498 A1
(43) Pub. Date: Jul. 16, 2015

(54) FLEXIBLE AND EFFICIENT SIGNALING AND CARRIAGE OF AUTHORIZATION ACQUISITION INFORMATION FOR DYNAMIC ADAPTIVE STREAMING

(71) Applicant: Furturewei Technologies, Inc., Plano, TX (US)

(72) Inventors: Yongliang LIU, HuiLongGuan Town (CN); Xin WANG, Rancho Palos Verdes, CA (US)

(21) Appl. No.: 14/594,928

(22) Filed: Jan. 12, 2015

Related U.S. Application Data
(60) Provisional application No. 61/926,184, filed on Jan. 10, 2014.

(51) Int. Cl. G06F 21/10; G06F 21/62

(52) U.S. Cl. CPC G06F 21/10; G06F 21/6218; G06F 2221/0753

(57) ABSTRACT

A robust encryption key management system for protecting content of a media content provider, the media content provider utilizing signaling fields in Media Presentation Description (MPD) files to indicate the information necessary to acquire authorization for a stream subsequent to the MPD. The access key(s) (e.g., authentication keys) to authorized protected content may be obtained online, via a specified uniform resource location, or offline, via derivation. Derivation of access keys is made according to a specified scheme, wherein protected content is organized according to a quality hierarchy, and wherein access keys for lower quality protected content are derived, in part, using higher quality access keys.

### RELATED U.S. APPLICATIONS

This application claims priority to U.S. Provisional Application No. 61/926,184, titled “Method for Flexible and Efficient Signaling and Carriage of Authorization Acquisition Information for Dynamic Adaptive Streaming,” filed on Jan. 10, 2014, which is hereby incorporated by reference in its entirety.

### BACKGROUND

Video streaming is becoming more and more popular, with video traffic exceeding 50 percent of the total traffic over content distribution networks (CDNs) according to some estimates. DASH (Dynamic Adaptive Streaming over HyperText Transfer Protocol (HTTP)) is designed to promote efficient delivery of multimedia content from servers to clients through HTTP-based content distribution networks.

In adaptive streaming, when delivering media content to a client device, the client device may select appropriate segments dynamically based on a variety of factors, such as network conditions, device capability, and user choice. Adaptive streaming may include various technologies or standards implemented or being developed, such as Dynamic Adaptive Streaming over Hypertext Transfer Protocol (HTTP) (DASH), HTTP Live Streaming (HLS), or Internet Information Services (IIS) Smooth Streaming. For example, the client device may select a segment with the highest quality (e.g., resolution or bit-rate) possible that can be downloaded in time for playback without causing stalling or rebuffering events in the playback. Thus, the client device may seamlessly adapt its media content playback to changing network conditions. To prevent tampering, attacks, and/or unauthorized access to media content, segments of the media content may need to be protected via authentication schemes, herein referred to as encryption or encoding schemes.

In adaptive streaming techniques such as Moving Picture Experts Group (MPEG)-DASH standard, segments may be encrypted or encoded as part of an authentication scheme, e.g., to accommodate a pay-per-view video stream model. One example is the segment authentication scheme specified in a draft standard numbered ISO/IEC 23009-4 and entitled “Dynamic Adaptive Streaming over HTTP (DASH)—Part 4: Segment Encryption and Authentication” (ISO/IEC 23009-4), incorporated herein by reference, where IEC stands for International Electrotechnical Commission (IEC). Conventional approaches have relied on a single algorithm approach for stream encoding, which may result in a large number of encryption keys and lead to difficulty in key management.

### SUMMARY

In embodiments according to this disclosure, these issues are addressed by providing, to a client, authorization information regarding encrypted portions of media content. Embodiments according to this disclosure also pertain to how the presence of authorization information is signaled to a client, how authorization is provided to a client, and how authorization is used by a client in adaptive streaming.

Disclosed herein are embodiments for a robust encryption key management system for protecting content of a media content provider, the media content provider utilizing signaling fields in Media Presentation Description (MPD) files to indicate the information necessary to acquire authorization for a stream subsequent to the MPD. The access key(s) (e.g., authentication keys) to authorized protected content may be obtained online, via a specified uniform resource location, or offline, via derivation. Derivation of access keys is made according to a specified scheme, wherein protected content is organized according to a quality hierarchy, and wherein access keys for lower quality protected content are derived, in part, using higher quality access keys.

In embodiments according to the present disclosure, different representations are associated with an instance of media content (e.g., a movie), and a representation can include multiple portions (e.g., segments or sub-segments) of media content. The different representations can each be encrypted, with a subscriber (via, e.g., a DASH client) able to access representations of a given quality based upon a subscription level. Encryption can be performed at various levels, including at the period level, the representation level, and the segment level.

In one embodiment, an apparatus includes a memory and a processor coupled to the memory. The processor is configured to obtain a description file for media content that includes a plurality of content objects, the description file including a protection description. The protection description includes data indicating a manner in which authorization for access to protected content objects of the plurality of content objects is acquired. The processor is configured to determine an authorization key associated with the protected content objects of the plurality of content objects. The authorization key is acquired by at least one of a uniform resource location and a derivation. The processor is configured to process the protected content objects according to their associated authorization key.

These and other objects and advantages of the various embodiments of the present disclosure will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a block diagram showing examples of components of a system (e.g., a DASH system) upon which embodiments according to the present disclosure can be implemented.

FIG. 2 illustrates a protocol diagram of a DASH communication method according to embodiments of the present disclosure.

FIG. 3 illustrates a schematic diagram of a DASH delivery process model according to embodiments of the present disclosure.

FIG. 4 is a schematic diagram of a DASH client process model according to embodiments of the present disclosure.

FIG. 5 is a flowchart of an example of a computer-implemented method for preparing media content, including authorization information, in embodiments according to the present disclosure.

FIG. 6 is a schematic diagram of a network element (NE) according to an embodiment of the present disclosure.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

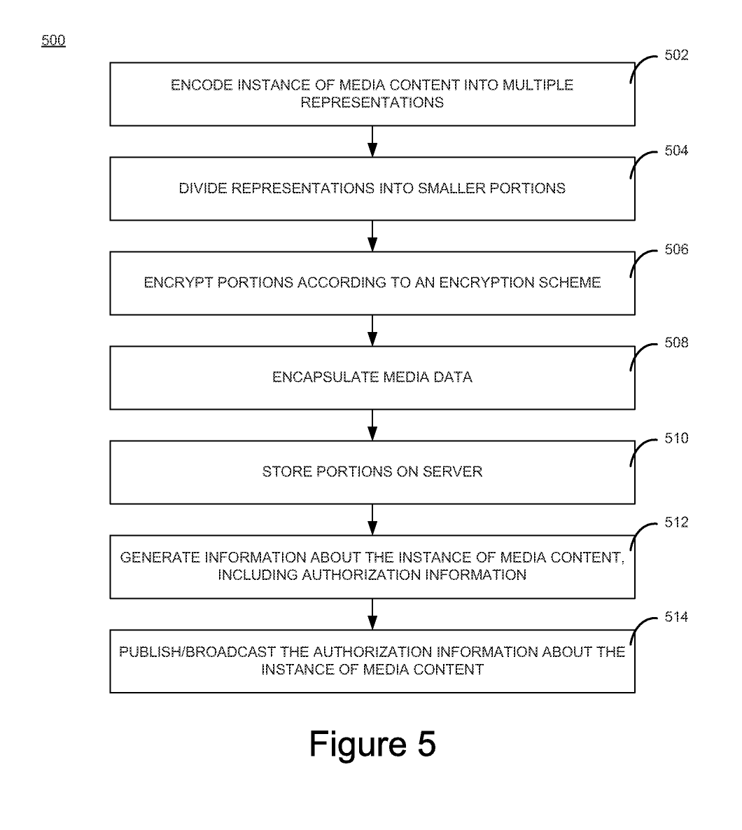

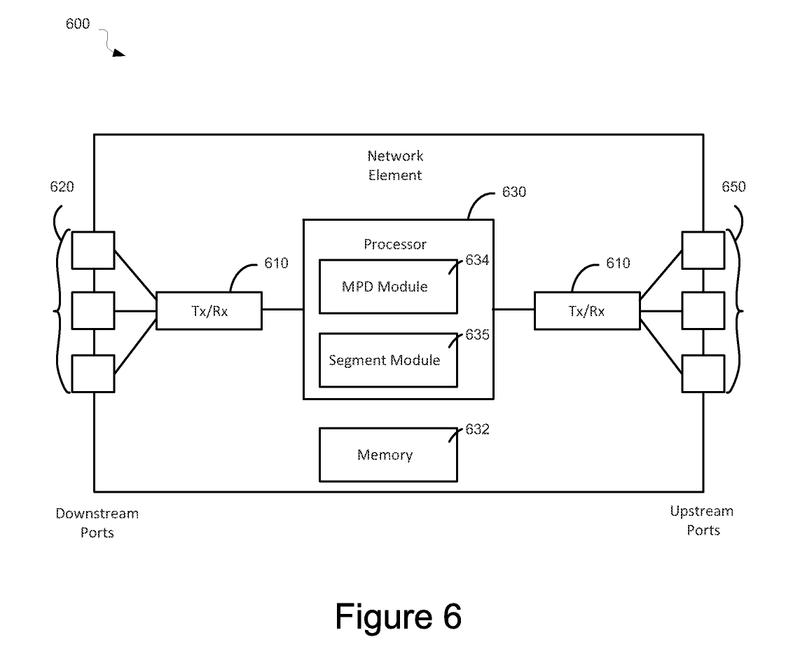

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “identifying,” “associating,” “accessing,” “requesting,” “using”, “indicating,” “retrieving,” “selecting,” “replacing,” “monitoring,” “providing.” “publishing,” “measuring,” “recording,” and “generating,” or the like, refer to actions and processes (e.g., flowchart 500 of FIG. 5) of a computer system or similar electronic computing device or processor (e.g., system 600 of FIG. 6). The computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

For simplicity, embodiments according to the present disclosure may be discussed in the context of DASH (Dynamic Adaptive Streaming over HTTP (HyperText Transport Protocol)), in some instances using DASH terminology. However, it is understood that embodiments according to the present disclosure are not necessarily limited to a DASH implementation, and that the use of DASH terminology does not necessarily limit such embodiments to a DASH implementation.

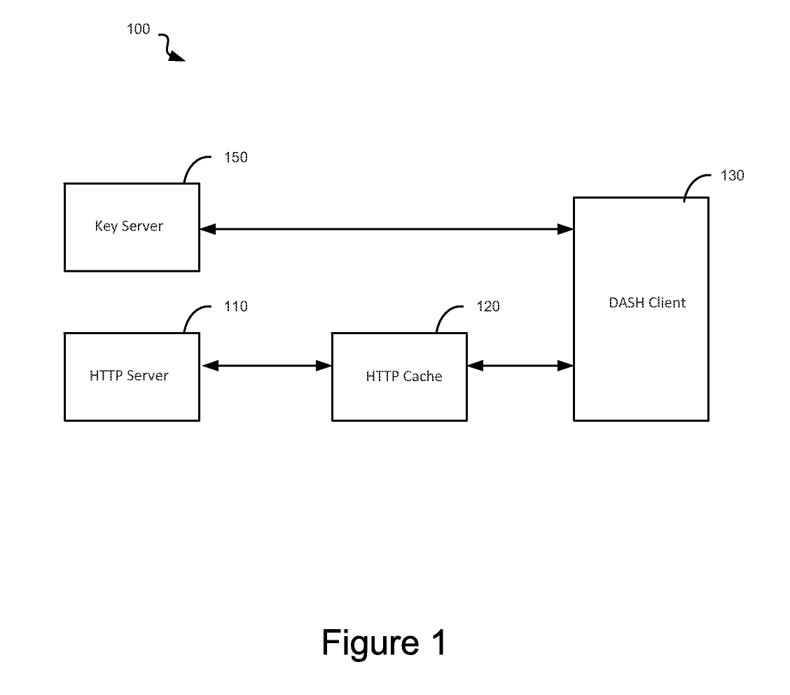

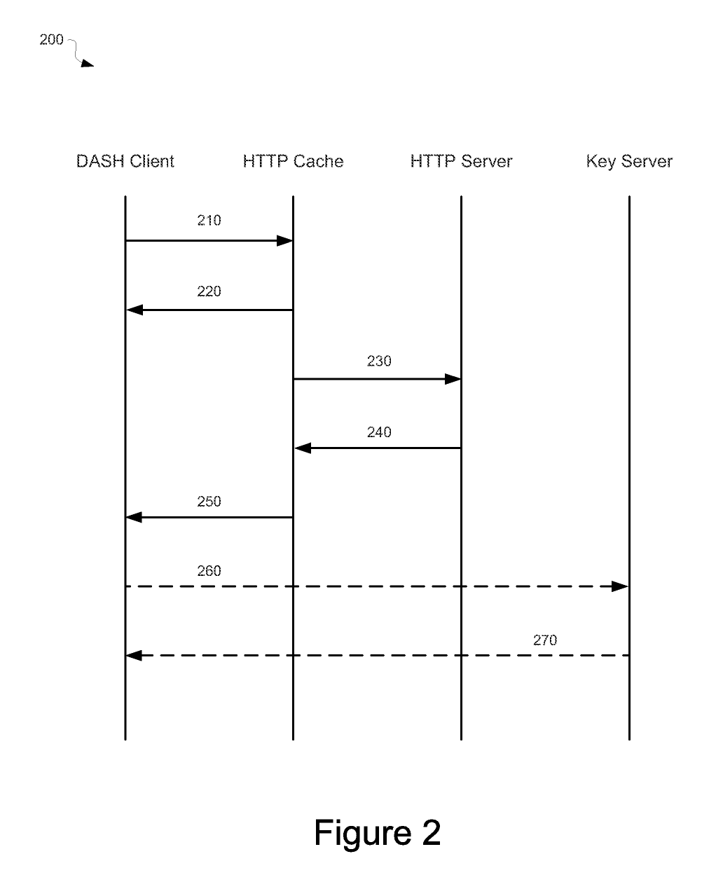

FIG. 1 is a schematic diagram of an embodiment of a DASH enabled network 100 architecture that communicates according to the protocol diagram of FIG. 2. Network 100 may comprise an HTTP server 110, a key server 150, an HTTP cache 120, and a DASH client 130 arranged as shown in FIG. 1. HTTP server 110 may be any device configured to service HTTP requests from DASH client 130. Key server 150 may be any device configured to service key and/or initialization vector (IV) requests from DASH client 130. In alternate license-based embodiments, key server 150 may be replaced with a license server, as would be understood by those of skill in the art. HTTP server 110 and key server 150 may be located on the same device, on different devices, or spread amongst a cluster of devices. For example, HTTP server 110 and/or key server 150 may comprise dedicated servers positioned in a data center. As another example, HTTP server 110 and/or key server 150 may operate as virtual machines (VMs) in a cloud computing environment. The HTTP server 110 may also be part of a content provider network or may be a node in a content distribution network (CDN). HTTP server 110 may populate an MPD file with information indicting URLs and/or a URL scheme, which may allow DASH client 130 to locate segment data. HTTP server 110 may further populate the MPD file with information indicting URLs and/or a URL scheme, which may allow DASH client 130 to locate the associated keys and/or IVs at the key server 150. HTTP server 110 may further populate the MPD file with any information DASH client 130 may require in order to present the data, such as period information, timing, segment format information, multiplexing information, etc. HTTP server 110 may then transmit the MPD file to DASH client 130 upon request. HTTP server 110 may also transmit segments and/or message authentication codes (MACs) to DASH client 130 upon request.

HTTP cache 120 may be any device configured to temporarily store information for rapid access by DASH client 130. For example, HTTP cache 120 may be a browser cache, which may be a software based cache stored on DASH client 130, a proxy cache, which may be a shared cache on DASH client 130's network, a gateway cache, which may be a shared cache installed in the same network as key server 150 and/or HTTP server 110, or combinations thereof. HTTP cache 120 may store segment data, MPD files, MACs and/or any other data DASH client 130 may require to present the media content.

DASH client 130 may be any device configured to obtain media content via a DASH protocol and present such media content to a user, such as a mobile phone, personal computer (PC), Internet Protocol (IP) television (TV), IP TV set top box, laptop PC, internet radio device, tablet PC, media storage device, etc. The DASH client 130 may present the content via a web browser, a media player, a video presenter, or any other program suitable for video and/or audio playback. The DASH client 130 may directly present the media content (e.g. visual data via a screen, audio data via a speaker, etc.) and/or may save and/or transmit the media content to other device(s) for presentation. The DASH client 130 may request an MPD file, for example via an HTTP GET request. The DASH client 130 may then review the MPD file to determine URLs for keys, IVs, MACs, ciphers, segments, etc. The DASH client 130 may also obtain any keys, IVs, MACs, ciphers, segments, etc., needed to display the media content, for example via an HTTP GET request(s) to the key server 150 and/or HTTP server 110, or via a derivation using information contained in the MPD, as described below. Upon receiving the necessary information, the DASH client 130, may decrypt the segment(s) with the cipher(s), key(s), and/or IVs, authenticate the segments(s) with the MAC, select and/or multiplex the segment data as directed by the MPD, and present the media content to the user and/or transmit the media content to another device for storage and/or presentation to the user. It should be noted that while only one DASH client 130 is shown for purposes of clarity, there may be many DASH clients 130 that may request the same and/or different media presentations from an HTTP server 110 at any specified time.

FIG. 2 is a protocol diagram of an embodiment of DASH communication method 200. At step 210, DASH client 130 may request data from an HTTP server 110 via an HTTP cache 120. The data may comprise an MPD, media content segments, or any other DASH associated data. Upon receiving requests from DASH client 130, the HTTP cache 120 may determine whether the requested data is already stored in the HTTP cache 120. If the data is stored, at step 220 the HTTP cache 120 may respond to the DASH client 130 request without forwarding the request to server 110. If the requested data is not stored in the HTTP cache 120, at step 230 the HTTP cache 120 may forward the request to HTTP server 110. At step 240, the HTTP server 110 may respond by transmitting the requested data to the HTTP cache 120. The HTTP cache 120 may forward the response to the requesting DASH client 130 at step 250, and/or save any data from the response for faster access at a later use by the same or a different DASH client 130.

According to an embodiment of the present disclosure, DASH client 130 may receive authorization keys for associated encrypted content via an MPD, as described in further detail below. Alternatively, based on data received from the HTTP cache 120, at step 260, DASH client 130 may request associated keys and/or IVs from the key server 150. At step 270, upon receiving the required components, either from an MPD or from key server 150. DASH client 130 may decrypt media content segments, arrange the media content contained in the segments according to an MPD, and present the media content to the user.

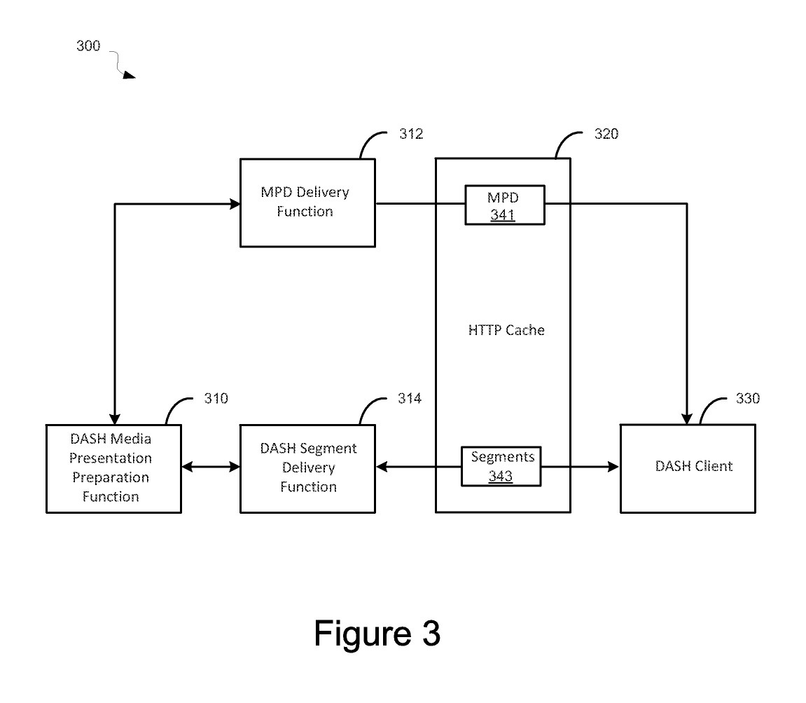

FIG. 3 is a schematic diagram of an embodiment of a DASH delivery process model 300. Model 300 may comprise a DASH media presentation preparation function 310, which may be implemented on a HTTP server, such as HTTP server 110, a content provider server, etc. Model 300 may further comprise an MPD delivery function 312 and a DASH segment delivery function 314, which may be implemented on a HTTP server such as HTTP server 110. Model 300 may further comprise a HTTP cache 320 and a DASH client 330, which may be substantially similar to HTTP cache 120 and DASH client 130, respectively. DASH media presentation preparation function 310, MPD delivery function 312, and DASH segment delivery function 314 may operate to transmit an MPD 341 and associated segments 343 to DASH client 330 via HTTP cache 320.

DASH media presentation preparation function 310 may be configured to prepare a media presentation for viewing by a DASH client 330. For example, the DASH media presentation preparation function 310 may receive data regarding media content from a CON and may prepare an MPD to describe the media content. The MPD can contain encrypted authorization keys for protected content, the encrypted keys provided in an open access manner. Alternatively or additionally, the MPD may list URLs for keys, IVs, ciphers, segments, and/or MACs. The MPD may list such URLs as static addresses and/or as functions that may be used to determine associated URLs. The MPD may be created using XML. An MPD may comprise information for one or more periods. Each period may comprise one or more adaptation sets. Each adaptation set may comprise one or more representations. Each representation may comprise one or more segments. A period may comprise timing data and may represent a content period during which a consistent set of encoded versions of the media content is available (e.g. a set of available bitrates, languages, captions, subtitles etc that do not change).

An adaptation set may represent a set of interchangeable encoded versions of one or several media content components. For example, a first adaptation set may comprise a main video component, a second adaptation set may comprise a main audio component, a third adaptation set may comprise captions, etc. An adaptation set may also comprise multiplexed content, such as combined video and audio. An adaptation set may comprise content corresponding to multiple views of an object or scene (e.g., stereo views of an object). A representation may describe a deliverable encoded version of one or more media content components, such as an ISO base media file format (ISO-BMFF) version, a Moving Picture Experts Group (MPEG) version two transport system (MPEG-2 TS) version, etc. A representation may describe, for example, any needed codecs, encryption, and/or other data needed to present the media content. A DASH client 330 is able to dynamically switch between representations based on network conditions, device capability, user choice, etc., which may be referred to as adaptive streaming. In a case where content is protected (e.g., via a subscription-level scheme), the ability of a DASH client 330 to dynamically switch between representations can be limited to those representations available to the subscription level of the subscriber. Each segment may comprise the media content data, may be associated with a URL, and may be retrieved by the DASH client 330, e.g. with an HTTP GET request. Each segment may contain a pre-defined byte size (e.g., 1,000 bytes) and/or an interval of playback time (e.g., 2 or 5 seconds) of the media content. A segment may comprise the minimal individually addressable units of data that can be downloaded using URLs advertised via the MPD. The periods, adaptation sets, representations, and/or segments may be described in terms of attributes and elements, which may be modified to affect the presentation of the media content by the DASH client 330. Upon preparing the MPD, the DASH media presentation preparation function 310 may deliver the MPD to the MPD delivery function 312.

The DASH client 330 may request the MPD 341 be delivered by the MPD delivery function 312. The MPD delivery function 312 may respond with the MPD 341 via the HTTP cache 320. Based on the address data in the MPD, the DASH client 330 may request appropriate segments 343 from the DASH segment delivery function 314. It should be noted that segments 343 may be retrieved from a plurality of DASH segment delivery functions 314 and/or from a plurality of URLs and/or physical locations. The DASH client 330 may present the retrieved segments 343 based on the instructions in the MPD 341.

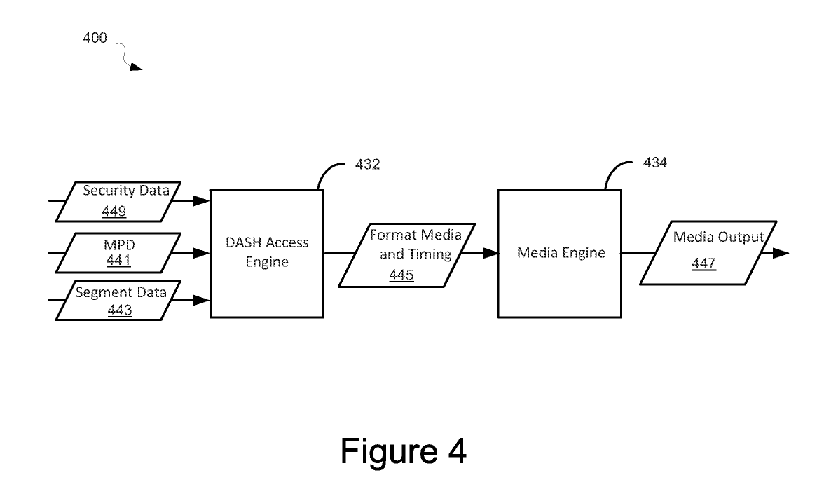

FIG. 4 is a schematic diagram of an embodiment of a DASH client process model 400. Model 400 may comprise a DASH access engine 432 and a media engine 434, which may be implemented in a DASH client, such as DASH clients 130 and/or 330. DASH access engine 432 may be any component configured to interpret an MPD, request media data, and receive such data. For example, DASH access engine 432 may request an MPD 441, such as MPD 341, from an MPD delivery function, such as MPD delivery function 312. Based on the MPD 441, DASH access engine 432 may also request segment data 443 from a DASH segment delivery function, such as DASH segment delivery function 314. Also based on the MPD 441, the DASH access engine 432 may request any security data 449, such as MACs from an HTTP server to authenticate the segment data 443 and/or ciphers, IVs, and/or keys from a key server such as key server 150 to decrypt the segment data 443. Once the segment data 443 has been decrypted and authenticated, the DASH access engine 432 may forward the format, media, and/or timing 445 to the media engine 434. The media engine 434 may be any component configured to receive the format, media, and/or timing 445 and prepare media output 447 based on the format, media, and/or timing 445. The media output 447 may be stored and/or transmitted to a component for presentation to a user (e.g. a screen, speaker, etc.).

Significantly, in embodiments according to the present disclosure, the information about an instance of media content also includes authorization information regarding client access to protected content. In a DASH implementation, the authorization information is included in the MPD.

Generally speaking, authorization information is generated and made available to the client 130. The authorization may be provided at the period level (e.g., one authorization per period), the representation level (e.g., one authorization sufficient for all segments in a representation of an instance of media content) or at the segment/sub-segment level (authorization per portion of an instance of media content). The authorization information included in the information about an instance of media content is able to indicate that content protection is present for that instance. The authorization information also indicates where authorization encryption keys reside (e.g., keys for decrypting content) and/or how those can be retrieved and/or derived.

The authorization acquisition can be provided “online” or “offline.” Below, the online and offline approaches are described. Then, the generation of encryption keys and their use according to embodiments of the present disclosure in adaptive streaming are described.

In one embodiment, the authorization information included in the information about the instance of media content (e.g., in the MPD) includes an element (e.g., an XML element) signaling the presence of protected content. Table 1 defines an XML element that can be included in the MPD in a DASH implementation. In other words, in a DASH implementation, the MPD is extended to include a new element (AuthorizationInfo).

Table 1 defines an example of an XML element that can be included in the MPD in a DASH implementation. In Table 1, the element name is “AuthorizationInfo,” and its attributes include “@objectId,” “@condition,” “@authId,” “@canBeDerived,” “@authAcqureUrlTemplate,” “@SchemeldUri,” “@algorithm,” “@dependencyAuthId,” “@parameter,” and “@keyLength.” The AuthorizationInfo element has a child element named “AuthAcquiWaylnfo,” which in turn has a child element named “Derivation.” In an embodiment, the AuthorizationInfo element is applied at the period level. In an embodiment, the AuthorizationInfo element is applied at the representation level. In an embodiment, the AuthorizationInfo element is applied at the segment level.

TABLE 1
Example of an MPD Element and Attributes

| Element or Attribute Name | | Use | Description |
|---|---|---|---|
| AuthorizationInfo | | | Specifies information necessary |
| | | | to acquire authorization for the |
| | | | appointed media content. |
| | Authorized Object | 0 . . . | Specifies the authorized content |
| | | N | object, e.g., a Representation, an |
| | | | AdaptationSet, or a Period, etc. |

| | | |
|---|---|---|
| @objectId | O | Specifies an identifier for the |
| | | authorized content object. The |
| | | identifier may also be the |
| | | segment number. |
| @condition | O | Specifies according to what |
| | | condition the client needs to play |
| | | the content object. |

| | | |
|---|---|---|
| @authId | O | Specifies an identifier for the |
| | | authorization of the appointed |
| | | content object(s). |
| AuthAcquiWayInfo | 0 . . . | Specifies the way to acquire |
| | N | authorization. |

| | | |
|---|---|---|
| @canBeDerived | O | Specifies if the authorization key |
| | | can be derived. Here, the |
| | | authorization key is generated in |
| | | some specified way(s). |
| @authAcquireUrlTemplate | O | Specifies the template for |
| | | authorization acquisition URL |
| | | generation. |
| Derivation | 0 . . . | Specifies the information to |
| | N | acquire authorization offline |

| | | |
|---|---|---|
| @SchemeIdUri | O | Specifies the scheme used for |
| | | deriving the authorization key. |
| @algorithm | O | Specifies the algorithm used for |
| | | computing the authorization key |
| @dependencyAuthId | O | Specifies the identifier for the |
| | | authorization that the current |
| | | authorization key depends on. |
| @parameter | O | Specifies the parameter used for |
| | | computing the authorization key |
| @keyLength | O | Specifies the length of the |
| | | authorization key in bits. If |
| | | absent, the key length is same as |
| | | in the algorithm. |

Legend: For attributes: M = Mandatory, O = Optional, OD = Optional with Default Value, CM = Conditionally Mandatory.
For elements: <minOccurs> . . . <maxOccurs> (N = unbounded)

An AuthorizationInfo element can signal the authorization information for one or more content objects. In order to signal the authorization information for more than one content object, preferably multiple AuthorizedObject children elements are present in one AuthorizationInfo element. At the same time, one or more AuthAcquiWaylnfo children element(s) are present, corresponding to the number of content elements. An AuthorizationInfo element can signal multiple ways for authorization acquisition for content object. An AuthorizationInfo element can signal authorization for partial representations, implemented for example by adding the attribute @objectId in the AuthorizationInfo. This manner of authorization signaling is particularly useful for support of multi-view video coding (MVC) content, as described herein.

The placement of an AuthorizationInfo element in the MPD is flexible. An AuthorizationInfo element can be placed as the MPD's children element to signal the authorization for some particular content representation. This is implemented by adding the attribute @objectId in the AuthorizationInfo. @objectId can also signal authorization information for single or multiple segments by adding the segment number(s) as the attribute @objectId in the AuthorizationInfo.

AuthorizationInfo element is able to carry the key derivation information for offline authorization in the case that authorization key is generated in a non-conventional manner, e.g., a lower quality representation key is encrypted or derived by a higher quality representation key (described below). The children element Derivation of the element AuthAcquiWayInfo is able to signal the key generation scheme, algorithm, the related higher quality authorization/key, the key length, as well as other parameters for computing the authorization key.

A segment key (SK) is used to encrypt each segment, while a representation key (RK) is used to encrypt all the corresponding SKs. The authorization keys correspond to a hierarchy of representations. For example, assuming a hierarchy of three levels of quality for three representations R3, R2, R1, where R3 is the highest quality content, one authorization key is generated for a high quality representation R3, a different authorization key is generated for a middle quality R2, and yet another distinct authorization key is generated for a low quality representation R1. The corresponding keys are RK3, RK2 and RK1 respectively. In general, a key management scheme according to the present disclosure includes a lower quality representation key that is encrypted by a higher quality representation key, and the encrypted key(s) are open access. After a client receives authorization for R3 (high quality), the client can also receive authorization for R2 and/or R1 by one of the following ways: (1) receiving the authorization for R2 or R1 in the same manner as receiving the authorization for R3, e.g. the client gets the authorization via the authorization server URL; (2) receiving an encrypted authorization key (e.g., representation key for middle quality encrypted by representation key for high quality, E_{RK3}(RK2)), then decrypting the encrypted authorization key to receive the authorization key of the lower quality content. These two forms of receiving authorization keys are termed as “online” and “offline,” described below.

### Online Authorization

In some embodiments according to present disclosure, authorization information for protected content can be acquired via a URL specified in the MPD. Such a case corresponds to the AuthorizationInfo element attribute, @authAcquireUrlTemplate. In particular. @authAcquireUrlTemplate specifies the template by which authorization acquisition via URL generation is to be made.

### Offline, or Derivation Mode, Authorization

According to embodiments of the present disclosure, in an offline mode a client is able to derive, via a supplied authorization key (e.g., an open access key), one or more authorization keys for accessing protected content. The Authorization Info attribute signaling the capability for derivation is the @canBeDerived attribute.

An exemplary key derivation function is defined as follows.

RKₙ₋₁=F(RKₙ,Par). (1)

where F( ) denotes an encryption key derivation function, Par denotes a parameter (for example, a random number), and n is the order of the key. That is, for a three-level hierarchy, n=3 can correspond to the highest quality representation, and n−1 is the nearest lower quality representation. Here three examples are described:
1) RK₂=F(RK₃, E_{RK3}(Par)), RK₂=F(RK₂, E_{RK2}(Par)). Note that the scheme is robust to certain brute force attacks because an attacker has no knowledge of E_{RKI}(Par), I=2 or 3
2) RK₂=E_{RK3}(F(RK₃, Par)), RK₁=E_{RK2}(F(RK₂, Par)). This scheme is also robust to certain known kinds of brute force attacks.
3) RK₂=E_{RK3}(E_{RK3}(Par)), RK₁=E_{RK2}(E_{RK2}(Par)). Note that the purpose of double encryptions is to prevent from a known plain text attack.

Various aspects and benefits of embodiments of the present disclosure may be better appreciated by describing several use cases, given below.

Use Case A: separate authorization exists for different content components (for example, video and audio). For example, if the DASH client 130 receives authorization for audio component only, the client cannot play the corresponding video component of the content. Unlike traditional television cable, where video and audio must be combined over one “stream” for delivery, content transport via HTTP allows different types of content to be delivered by different HTTP connections. Therefore, for example, audio could be retrieved from a first source different than the source used to obtain the video. As another example, audio streams and/or captions may be present in several different languages, for the same content. Authorization for these can be obtained separately, providing flexibility for content providers.

Use Case B: A single authorization request (or acquisition) enables retrieval of authorization for all components associated with the content. In general, the process of determining authorization is making a determination of whether a client has permission to receive a key to access protected content. The actual retrieval of the encryption key is typically made in a separate step. However, in this particular case, the process for a client to receive authorization and the process to get a key for the client are one, as authorization necessarily entails access to all components associated with the protected content.

Use Case C: quality-based subscription. For example, free content may be restricted to a lower (or lowest) quality representation, or perhaps several lower quality representation levels. However, higher quality representations may be premium, requiring a paying subscription, or membership. Authorization for access to higher quality representations is preferably configured to automatically trigger authorization for the client to access all lower quality representations, especially to enable dynamic adaptation. This is due to the fact that If higher quality representations are authorized exclusively, without authorization for lower quality representations, then only higher quality segments are able to be retrieved and cached, which will result in poor streaming performance in the case when network performance is low for a client device. Therefore, according to an embodiment of the present disclosure, access to lower quality representations is automatically enabled when access to high quality representation(s) is authorized. In addition to increasing streaming performance for a client device, this can also reduce the number of required encryption keys for protected content, if the required keys for lower quality segments can be derived from the keys of higher quality segments (as described above for offline derivation).

A further aspect of quality-based subscription is the ability of the system to authorize sharing amongst several client devices operated by a single user. That is, when streaming is authorized to one of several devices used by a single user, other devices are preferably enabled to access protected content for streaming.

Use Case D: content encoding subscription. According to embodiments of the present disclosure, authorization to access protected content can be granted based upon a type of encoding present in the media content. For example, scalable video coding (SVC) functions by having a lower quality (e.g., lower bit-rate) encoded layer as a base layer, which is always present in a content stream. A higher quality version is provided by enhancing the baseline encoding with additional content, such that the content stream comprises the lower quality stream plus the additional content. Further, the highest quality version includes the encoding of the lower two, and includes yet more enhancement. Thus a lower quality level is base layer, a medium quality level has Its own enhancement layer, and a highest quality level has its own enhancement layer.

When content is prepared, a first representation is prepared for the lower quality level. The medium quality level representation is not a standalone representation, but rather a representation for the enhancement only. Thus, a client always receives the lower quality stream. If the medium quality content is authorized, the medium quality enhancement segment is retrieved. The combination of the lower quality level segment and the medium quality level enhancement segment gives the medium quality content stream. Therefore, providing access to high quality level segment entails access to the low quality level segment, plus the combination of the medium quality level and high quality level enhancements above the low quality level segment.

Another example of hierarchy via encoding is multi-view coding (MVC) MVC includes content from several sources, for example, several cameras recording a playing field. The MVC views can be considered to have a base view of an object, or field, with various enhancement cameras recording from varied angles. If cameras recording same field of view, the camera recordings may have some overlap (encoded view), that is, redundancy. Therefore, an encoding of the base view may be considered the “low” quality view, that is, the standard view. All other views may be considered as enhancements to that base view. It should be noted that there can be different video quality associated with each view, that is, not all of the views may be of the same resolution, aspect ratio, etc.

According to embodiments of the present disclosure, each view in the MVC corresponds to an adaptive set, so that each view can have a different quality; and, there are multiple views. In DASH this can be encoded into multiple adaptive sets. In the situation where there is a base view, and different views considered to be enhancements to the base view, then authorization can be tiered. For example, basic (or standard) authorization can include base view. Other views can be higher levels of authorization, requiring membership, or payment levels. In this manner, deriving authorization for the various views of MVC can be made analogous to a hierarchical arrangement of representations corresponding with higher to lower quality.

### Preparation of Media Content

FIG. 5 is a flowchart 500 of an example of a computer-implemented method for preparing media content, including authorization information, in embodiments according to the present disclosure. The flowchart 500 can be implemented as computer-executable instructions residing on some form of non-transitory computer-readable storage medium. The operations of the flowchart 500 can be implemented on the server side of the system 100 of FIG. 1 (e.g., by the HTTP server 110, or by one or more servers communicatively coupled to HTTP server 110) Although described using a single instance of media content as an example, the operations can be readily extended to multiple instances of media content.

In block 502 of FIG. 5, an instance of media content is encoded into multiple representations. The representations can differ in, as non-limiting examples, bit-rate, resolution, and/or category (e.g., video, and audio).

In block 504, in one embodiment, each representation is divided into smaller portions (e.g., segments/sub-segments). The portions may be of different lengths (different time durations).

In block 506, the portions are encrypted according to an encryption scheme. Encryption can be made according to techniques known in the art, or alternatively, by one or more of the encryption schemes described herein (e.g., as described above regarding derivation mode).

In block 508, the representations are encapsulated into segment(s), which may be further divided into sub-segments.

In block 510, the portions (segments/sub-segments) are sent to and stored on a server (e.g., HTTP server 110 of FIG. 1).

In block 512, information about the Instance of media content (e.g., an MPD) is generated, describing what media content is available and how it can be accessed and retrieved. According to embodiments of the present disclosure, information about the instance of media content (e.g., an MPD) includes authorization information (e.g., as specified in Table 1). The authorization information indicates the protection status of the content (that is, whether the content is encrypted), and if protected, further includes information specifying the manner in which a client is able to determine authorization for the content.

In an embodiment including encryption key retrieval, in a DASH implementation, the authorization information includes an AuthAcquireUrlTemplate element in the MPD, described above.

In an embodiment including offline encryption key derivation, in a DASH implementation, the quality information includes a canBeDerived element, described above.

In block 514, information about the instance of media content, including authorization information (e.g., an MPD), is published and is accessible to a client, e.g., on a Web page, using a URL. A client can access the information about the instance of media content using, for example, a Web browser, e-mail, Short Message Service (SMS), etc.

FIG. 6 is a schematic diagram of an embodiment of a network element (NE) 600 which may act as a DASH server, such as HTTP server 110, a key server 150, a DASH media presentation preparation function 310, an MPD delivery function 312, and/or a DASH segment delivery function 314, within a network and/or model such as network 100 and/or model 300, and may be configured to generate MPDs and/or transmit segments to a DASH client such as DASH client 130, and/or 330. NE 600 may be implemented in a single node or the functionality of NE 600 may be implemented in a plurality of nodes in a CDN, or other content based network. In some embodiments NE 600 may also act as other node(s) in network 100 and/or model 300. One skilled in the art will recognize that the term NE encompasses a broad range of devices of which NE 600 is merely an example. NE 600 is included for purposes of clarity of discussion, but is in no way meant to limit the application of the present disclosure to a particular NE embodiment or class of NE embodiments. At least some of the features/methods described in the disclosure may be implemented in a network apparatus or component such as an NE 600. The NE 600 may be any device that transports frames through a network, e.g., a switch, router, bridge, server, a client, etc. As shown in FIG. 6, the NE 600 may comprise transceivers (Tx/Rx) 610, which may be transmitters, receivers, or combinations thereof. A Tx/Rx 610 may be coupled to a plurality of downstream ports 620 (e.g. downstream interfaces) for transmitting and/or receiving frames from other nodes and a Tx/Rx 610 coupled to plurality of upstream ports 650 (e.g. upstream interfaces) for transmitting and/or receiving frames from other nodes, respectively. A processor 630 may be coupled to the Tx/Rxs 610 to process the frames and/or determine which nodes to send frames to. The processor 630 may comprise one or more multi-core processors and/or memory devices 632, which may function as data stores, buffers, etc. Processor 630 may be implemented as a general processor or may be part of one or more application specific integrated circuits (ASICs) and/or digital signal processors (DSPs). Processor 630 may comprise an MPD module 634 and/or a segment module 635. The MPD module 634 may prepare an MPD and/or forward the MPD toward a client upon request. The segment module 635 may forward segments toward the client upon request. In an alternative embodiment, the MPD module 634 and/or a segment module 635 may be implemented as instructions stored in memory 632, which may be executed by processor 630. In another alternative embodiment, the MPD module 634 and the segment module 635 may be implemented on separate NEs. The downstream ports 620 and/or upstream ports 650 may contain electrical and/or optical transmitting and/or receiving components.

It is understood that by programming and/or loading executable instructions onto the NE 500, at least one of the processor 630, MPD module 634, segment module 635, downstream ports 620, Tx/Rxs 610, memory 632, and/or upstream ports 650 are changed, transforming the NE 600 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. An apparatus comprising:
a memory for storing a description file for media content;
a processor coupled to the memory, the processor configured to obtain the description file for media content comprising a plurality of content objects, the description file comprising a protection description including data indicating a manner in which authorization for access to protected content objects of the plurality of content objects is acquired, wherein the processor is configured to determine a first authorization key associated with the protected content objects of the plurality of content objects, the first authorization key acquired by at least one of a uniform resource location and a derivation from a second authorization key, wherein the processor is configured to process the protected content objects according to their associated authorization key.

2. The apparatus of claim 1, wherein the plurality of content objects is organized according to a hierarchy arranged from a highest to a lowest quality.

3. The apparatus of claim 2, wherein the first authorization key is associated with protected content objects of a lower quality and is a derivation from the second authorization key, wherein the second authorization key is associated with protected content objects of a higher quality.

4. The apparatus of claim 3, wherein the derivation from the second authorization key comprises a hash derivation function using the second authorization key.

5. The apparatus of claim 3, wherein the derivation from the second authorization key comprises a hash derivation function including a hash of a combination of the second authorization key and a random parameter.

6. The apparatus of claim 2, wherein the first authorization key is associated with protected content objects of a lower quality and is prevented from processing protected content objects of a higher quality.

7. The apparatus of claim 2, wherein the hierarchy is based upon quality information of the content objects, the quality information comprising at least one of a bit-rate, a resolution, a content quality, and a number of channels.

8. The apparatus of claim 1, wherein the second authorization key is included in the description file.

9. A non-transitory computer-readable storage medium having computer-executable instructions that, when executed by a processor, cause an apparatus to:
obtain a description file for media content comprising a plurality of content objects, the description file comprising a protection description including data indicating a manner in which authorization for access to protected content objects of the plurality of content objects is acquired, the access enabled by a first authorization key,
determine the first authorization key associated with the protected content objects of the plurality of content objects, the first authorization key acquired by at least one of a uniform resource location and a derivation from a second authorization key; and
process the protected content objects according to their associated authorization key.

10. The non-transitory computer-readable storage medium of claim 9, wherein a plurality of different periods is associated with the plurality of content objects, periods of the plurality of periods having respective authorization keys associated therewith, wherein a respective authorization key of a period enables access to protected content objects of the plurality of content objects associated with the period.

11. The non-transitory computer-readable storage medium of claim 9, wherein a plurality of different periods is associated with the plurality of content objects, the different periods in the plurality of periods comprising a plurality of representations of the plurality of content objects, the representations in the plurality of representations having respective authorization keys associated therewith, wherein a respective authorization key of a representation enables access to protected content objects of the plurality of content objects associated with the representation.

12. The non-transitory computer-readable storage medium of claim 9, wherein a plurality of different representations is associated with the plurality of content objects, the different representations in the plurality of representations comprising a plurality of portions of the plurality of content objects, the portions in the plurality of portions having respective authorization keys associated therewith, wherein a respective authorization key of a portion enables access to protected content objects of the plurality of content objects associated with the portion.

13. A method comprising:
obtaining a media content comprising a plurality of content objects comprising at least one protected content object;
generating a description file for the media content, the description file comprising a protection description including data indicating a manner in which authorization for access to the at least one protected content object is acquired, the authorization for access acquired by at least one of a uniform resource location and a derivation from a second authorization key; and
transmitting the protection description and the media content to a client.

14. The method of claim 13, wherein the plurality of content objects is organized according to a hierarchy arranged from a highest to a lowest quality.

15. The method of claim 14, wherein the at least one protected content object is of a lower quality, and wherein the authorization for access comprises a first authorization key derived from the second authorization key, the second authorization key configured to process protected content objects of a higher quality.

16. The method of claim 15, wherein the first authorization key is computed from a hash derivation function using the second authorization key.

17. The method of claim 15, wherein the first authorization key is computed from a hash derivation function including a hash of a combination of the second authorization key and a random parameter.

18. The method of claim 14, wherein the at least one protected content object is of a lower quality, and wherein the authorization for access comprises a first authorization key prevented from processing protected content objects of a higher quality.

19. The method of claim 14, wherein the hierarchy is based upon quality information of the content objects, the quality information comprising at least one of a bit-rate, a resolution, a content quality, and a number of channels.

20. The method of claim 13, wherein the second authorization key is included in the description file.
